(19) United States
(12) Patent Application Publication
(10) Pub. No.: US 2025/0318566 A1
(43) Pub. Date: Oct. 16, 2025

(54) CREATION PROCESS OF EDITABLE STRAW

(71) Applicant: Walberto Noé GARCÍA AGUILERA, Mexcio City (MX)

(72) Inventor: Walberto Noé GARCÍA AGUILERA, Mexcio City (MX)

(21) Appl. No.: 18/735,486

(22) Filed: Jun. 6, 2024

(30) Foreign Application Priority Data
Apr. 16, 2024 (MX) MX/A/2024/004664

(51) Int. Cl. A23P 30/25; A23L 29/212; A47G 21/18

(52) U.S. Cl. CPC A23P 30/25; A23L 29/212; A47G 21/18

(57) ABSTRACT

A composition to prepare an editable straw is provided. The straw is manufactured from a mixture comprising corn. The straw supports being submerged in an editable liquid without transferring color or flavor to the beverage.

### FIELD OF INVENTION

The present invention belongs to the technical field of packaging. Specifically, the present invention provides a creation process of an editable straw.

### BACKGROUND OF THE INVENTION

The document US2023270150 (A1) describes a biodegradable straw of low cost that comprehends cornstarch structurally altered mixed with one or more of an improver.

The document NL2030595 (B1) describes a green food based on straw and Morchella esculenla mushrooms.

The document CN113854539 (A) describes a method of preparation of scented straws and is related with the technical field of the preparation methods of scented straws.

The document US2021259443 (A1) describes one piece of editable cutlery and one method to create the piece of editable cutlery.

The document CN110313783 describes one formula and one preparation method of an editable straw.

### OBJECTIVES OF THE INVENTION

It is an object of the present invention to provide a straw made from editable corn.

It is another object of the present invention to provide a process of manufacturing an editable straw using corn as the main raw material.

### DETAILED DESCRIPTION OF THE INVENTION

The present invention provides a composition to prepare an editable straw. The editable straw is prepared from the following components in percentage of mass: 50-70% of cornstarch, 10-20% of Glycerin, 5-6% of Tapioca, 20-40% of water, 2 to 2.5% of flavoring and 1% to 0.5% of colorant.

In one modality of the present invention the flavoring and colorant can be natural, artificial or a combination of the same.

The composition of the straw permits it to have a duration in a beverage of more than 8 hours without falling apart. The beverage is selected from water, soda, lemonade, orange drink or any type of beverage at a temperature no more than 30 C. Also, the straw does not transfer color to the beverage where it's submerged DURING 8 HOURS.

The straw is manufactured by means of an extruder designed especially for this product. The method of preparation comprehends the following steps:
the materials in the formula are weighed in its proportion and placed in a mixer with vigorous agitation until having a homogeneous mixture;
the mixture is transferred directly to an extruder of one or two screws, the extruder pushes the materials forward producing the formation of the straw;
the materials are extruded linearly and then passed by a drying tunnel to then be cut by a cutting machine in accordance to the size required;
finally, the finished products are packaged using a paper casing machine or directly in its box.

The editable straws are conserved stable by being submerged during more than 8 hrs. in a beverage; then they get moist so they can be eaten or thrown away; they don't transfer the color to the beverage, they are very light and have a very pleasant taste. Also, the formulation of the straws permits them to be at a lower price.

1. One composition to prepare an editable straw, characterized because it comprehends the following components in percentage of mass: 50-70% of cornstarch, 10-20% of Glycerin, 5-6% of Tapioca, 20-40% of water, 2 to 2.5% of flavoring and 1% to 0.5% of colorant.

2. The composition in accordance with the claim 1, characterized also because the flavoring and colorant can be natural, artificial or a combination of the same.

3. The composition in accordance with the claim 1, characterized also because the straw has a duration in the beverage of more than 8 hrs. without falling apart.

4. The composition in accordance with the claim 1, characterized also because the beverage is selected from water, soda, lemonade, orange drink or any type of beverage.

5. A preparation method of an editable straw, characterized because it comprehends the following steps:
50-70% of cornstarch, 10-20% of Glycerin, 5-6% of Tapioca, 20-40% of water, 2 to 2.5% of flavoring and 1% to 0.5% of colorant is weighed and placed in a mixer with vigorous agitation until having a homogeneous mixture;
the mixture is transferred directly to an extruder of one or two screws, the extruder pushes the materials forward producing the formation of the straw:
the materials are extruded linearly and then passed by a drying tunnel to then be cut by a cutting machine in accordance to the size required;
finally, the finished products are packaged using a paper casing machine or directly in its box.
